(19) United States
(12) Patent Application Publication
(10) Pub. No.: US 2025/0297495 A1
(43) Pub. Date: Sep. 25, 2025

(54) BICYCLE LOCK

(71) Applicant: ABA Locks International Co., Ltd., New Taipei City (TW)

(72) Inventor: Miko Lee, New Taipei City (TW)

(73) Assignee: ABA Locks International Co., Ltd., New Taipei City (TW)

(21) Appl. No.: 18/631,775

(22) Filed: Apr. 10, 2024

(30) Foreign Application Priority Data
Mar. 23, 2024 (TW) 113201871

(51) Int. Cl. E05B 71/00

(52) U.S. Cl. CPC E05B 71/00

(57) ABSTRACT

A bicycle lock has a lock casing, a lock core assembly, a lock bar, and a lock cable. The lock casing has a front end surface, a back end surface, a peripheral surface, an installation slot, a fixed pin, a lock core recess, and a cable slot. The installation slot is recessed from the peripheral surface. The fixed pin is secured in the installation slot. The lock core recess is recessed from the front end surface. The lock core assembly is movably mounted in the lock core recess. The lock bar is connected to the lock core assembly and is capable of moving into the installation slot. The lock cable is detachably mounted in the cable slot of the lock casing. The bicycle lock can be fixed on a chain of a bicycle to interfere with operation of the chain, thereby preventing theft

### CROSS-REFERENCE TO RELATED APPLICATIONS

This application claims the benefit of Taiwan Patent Application No. 113201871, filed on Feb. 23, 2014, which is herein incorporated by reference in its entirety.

### FIELD OF THE INVENTION

The present invention relates to a bicycle lock, especially to a bicycle lock that is capable of being locked on a chain of a bicycle.

### BACKGROUND OF THE INVENTION

Bicycle locks are provided in various configurations and may be roughly divided into two types according to the mechanisms. One type of the bicycle locks is to be locked on actuating parts of the bicycle, such that the bicycle is incapable of moving normally, so as to prevent theft. The other type of the bicycle locks is to connect the bicycle to an external fixed structure, for example, to lock and connect the bicycle to a fence to prevent theft.

Conventionally, a wheel lock is common among the bicycle locks to be locked on actuating parts of the bicycle and is commonly and broadly used. When in application, the wheel lock is hung on a rim and located between spokes of the wheel, but since the wheel lock occupies too much space and weighs too much, a structure of the wheel may be damaged easily. The wheels are important and expensive components in a bicycle, and thus the wheel lock may cause troubles to the user. Furthermore, although the bicycle cannot be ridden after locked by the wheel lock, the bicycle may still be stolen by carrying the whole bicycle away.

Hence, many users decide to use the bicycle lock which connects the bicycle to the external fixed structure. The users fix their bicycles on the external fixed structures such as the fences, parking racks, or trees to prevent theft. However, though the bicycle locks connecting the bicycle to the external fixed structure increase an anti-theft effect, said bicycle locks are difficult to use and may cause troubles to the user.

To be more precise, the bicycle lock has a lock body and a cable part, the lock body may be a U-shaped lock which is applied on the wheel or the frame, and the cable part may be a chain or a rope. The user needs to wrap the cable part around the bicycle and the external fixed structure first, and then holds on tight to the cable part to engage an end of the cable part with the lock body, thereby fixing and locking the bicycle on the external fixed structure. Once the cable part is not long enough to be wrapped properly during said process, the user has to remove the whole bicycle lock from the bicycle, adjust a distance between the bicycle and the external fixed structure, and wrap the cable part on the bicycle and the external fixed structure again, until the cable part can be properly wrapped on the bicycle and the external fixed, consuming stamina and time a lot. In addition, the user has to unlock the lock body and then engage an end of the cable part with the lock body while the cable part is tightly wrapped on the bicycle and the external fixed structure, and thus it is difficult for the user to complete the process. The process may be difficult to accomplish especially to those limited in mobility or strength such as the elderly or the children.

To overcome the shortcomings, the present invention provides a bicycle lock to mitigate or obviate the aforementioned problems.

### SUMMARY OF THE INVENTION

The main objective of the present invention is to provide a bicycle lock that is capable of being locked on a chain of a bicycle.

The bicycle lock includes a lock casing, a lock core assembly, a lock bar, and a lock cable. The lock casing has a front-back direction, and the lock casing includes a front end surface, a back end surface, a peripheral surface, an installation slot, a fixed pin, a lock core recess, and a cable slot. The front end surface and the back end surface are located on two opposite ends of the lock casing along the front-back direction. The peripheral surface connects with the front end surface and the back end surface. The installation slot is recessed from the peripheral surface and adjacent to the back end surface. The installation slot has a penetrating direction non-parallel to the front-back direction. The fixed pin has an end secured on a bottom surface of the installation slot. The lock core recess is recessed from the front end surface of the lock casing, and the lock core recess includes a communicating hole formed through a bottom surface of the lock core recess, and thereby the lock core recess and the installation slot spatially communicate with each other. The cable slot is recessed from the peripheral surface. The lock core assembly is movably mounted in the lock core recess. The lock bar has an end connected to the lock core assembly, another end of the lock bar is disposed through the communicating hole, and the lock bar is capable of moving into the installation slot. The lock cable is detachably mounted in the cable slot of the lock casing.

Set a chain of the bicycle in the installation slot, insert the fixed pin into a hole of the chain, and block the chain with the lock bar to prevent separation from the installation slot to further fix a relative position of the chain with respect to the lock casing, and thus the bicycle lock is fixed and locked on the chain. Since the fixed pin is inserted into the chain, and the lock bar blocks the chain, the bicycle lock would move along with the chain. The chain would be interfered and incapable of working normally, thereby preventing the bicycle from theft. To compare with a wheel lock, the bicycle lock would not damage a rim and spokes of a wheel. The bicycle lock does not have a lock body unremovable from the lock cable, and the bicycle lock can be easily fixed on the bicycle even though the lock cable is wrapped a little tightly. The bicycle lock does not have the lock body occupying large space which leads to difficulties about crossing gaps, and thus the user can wrap the lock cable at the sites of the bicycle as desired. Furthermore, when unlocking the bicycle lock, after the plug is separated from the cable slot, the lock cable can be disconnected from the lock casing, and thus the user can easily remove the lock cable from the frame of the bicycle and the external fixed structure.

Other objectives, advantages and novel features of the invention will become more apparent from the following detailed description when taken in conjunction with the accompanying drawings.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a perspective view of a bicycle lock in accordance with the present invention;

FIG. 2 is a perspective view of the bicycle lock in FIG. 1, shown without a lock cable;

FIG. 3 is an exploded view of the bicycle lock in FIG. 2;

FIG. 4 is another exploded view of the bicycle lock in FIG. 3, shown in another view angle;

FIG. 5 is a perspective view of a lock core assembly of the bicycle lock in FIG. 2, showing a part of the lock core assembly and showing a core fixing bar and a pressing protrusion abut each other;

FIG. 6 is a top side view of the lock core assembly of the bicycle lock in FIG. 2, shown with an inner base transparent and without a core sleeve;

FIG. 7 is a cross-sectional view of the of the bicycle lock taken across line 7-7 in FIG. 23;

FIG. 8 is a cross-sectional view of the bicycle lock taken across line 8-8 in FIG. 22, shown with a lock casing partially omitted;

FIG. 9 is a cross-sectional view of the bicycle lock taken across line 9-9 in FIG. 22;

FIG. 10 is a side view of the bicycle lock in FIG. 2, shown unlocked and with the lock casing transparent;

FIG. 11 is a cross-sectional side view of the bicycle lock in FIG. 1, shown unlocked and with the cable body omitted;

FIG. 12 is a cross-sectional top view of the bicycle lock in FIG. 2, shown unlocked;

FIG. 13 is a cross-sectional front view of the bicycle lock in FIG. 2, shown unlocked;

FIG. 14 is an operational perspective view of the bicycle lock in FIG. 1, shown fixed on a chain;

FIG. 15 is a side view of the bicycle lock in FIG. 14, showing the chain cross-sectional;

FIG. 16 is an operational perspective view of the bicycle lock in FIG. 1, shown engaged with a brake disc of a wheel and fixed to an external fixed structure;

FIG. 17 is a side view of the bicycle lock in FIG. 16, showing the brake disc cross-sectional;

FIG. 18 is an operational perspective view of another embodiment of a bicycle lock in accordance with the present invention, shown connected to a saddle of a bicycle by a connector;

FIG. 19 is a perspective view of the bicycle lock in FIG. 18;

FIG. 20 is an exploded view of the bicycle lock in FIG. 19;

FIG. 21 is a partial cross-sectional side view of the bicycle lock in FIG. 19;

FIG. 22 is a side view of the bicycle lock in FIG. 1; and

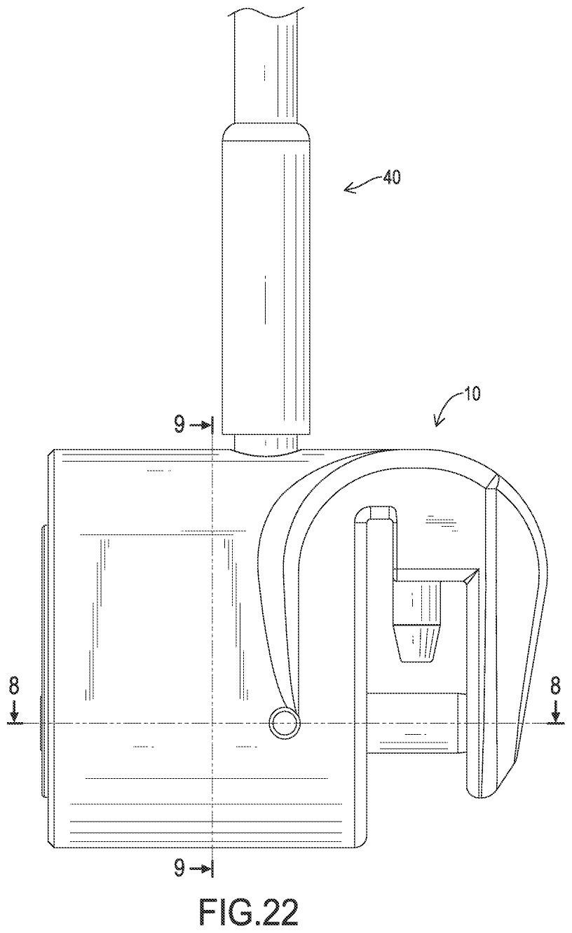

FIG. 23 is a top view of the bicycle lock in FIG. 2.

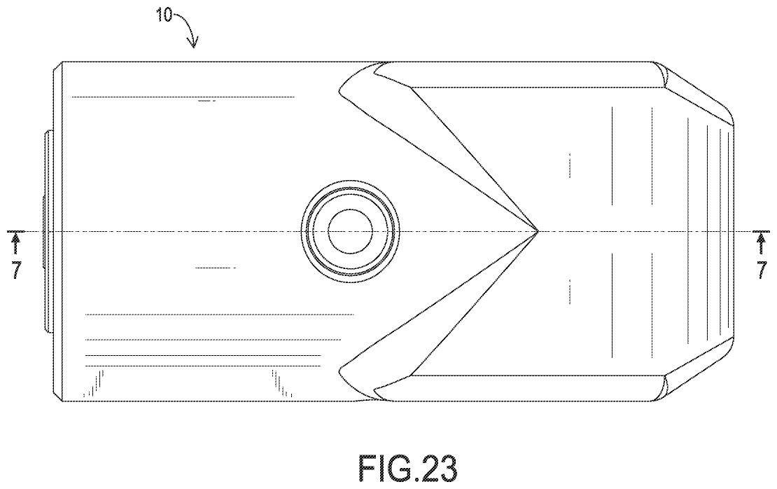

### DETAILED DESCRIPTION

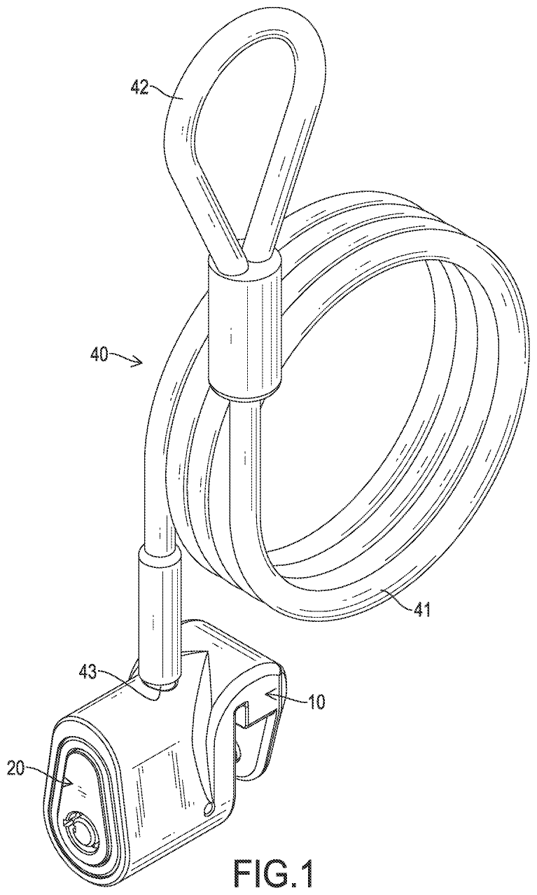

With reference to FIGS. 1 to 4, a bicycle lock in accordance with the present invention includes a lock casing 10, a lock core assembly 20, a lock bar 30, a lock cable 40, and a connector 50.

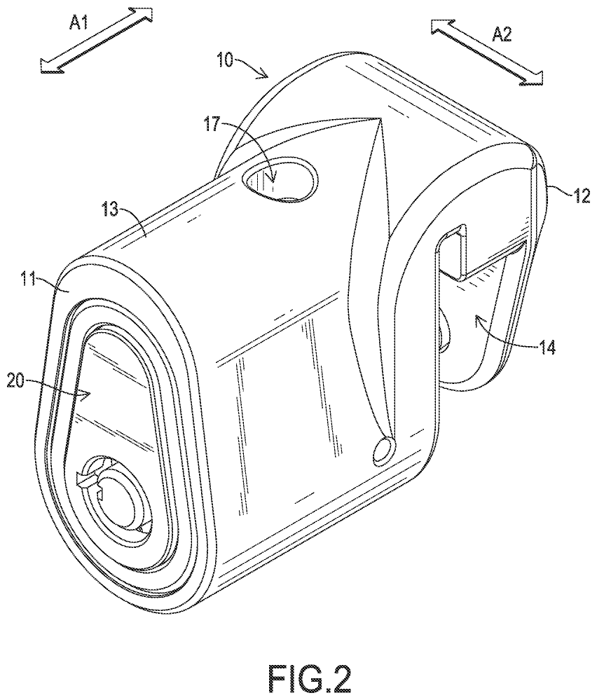

With reference to FIGS. 2 to 4 and 7 to 8, the lock casing 10 has a front-back direction A1, the lock casing 10 includes a front end surface 11, a back end surface 12, a peripheral surface 13, an installation slot 14, a fixed pin 15, a lock core recess 16, and a cable slot 17.

The front end surface 11 and the back end surface 12 are located on two opposite ends of the lock casing 10 along the front-back direction A1, and the peripheral surface 13 connects with the front end surface 11 and the back end surface 12. The installation slot 14 is recessed from the peripheral surface 13, and is adjacent to the back end surface 12. The installation slot 14 has a penetrating direction A2, the penetrating direction A2 is non-parallel to the front-back direction A1, and the installation slot 14 penetrates the lock casing 10 along the penetrating direction A2.

An end of the fixed pin 15 is secured on a bottom surface of the installation slot 14, and another end of the fixed pin 15 extends away from the bottom surface of the installation slot 14.

The lock core recess 16 is recessed from the front end surface 11 of the lock casing 10, the lock core recess 16 has a communicating hole 161, an outer lock hole 162, and a limit track 163. The communicating hole 161 is formed through a bottom surface of the lock core recess 16, and thereby the lock core recess 16 and the installation slot 14 spatially communicate with each other. The outer lock hole 162 is recessed from an inner wall surface of the lock core recess 16. The limit track 163 is recessed from the inner wall surface of the lock core recess 16, and the limit track 163 extends along the front-back direction A1.

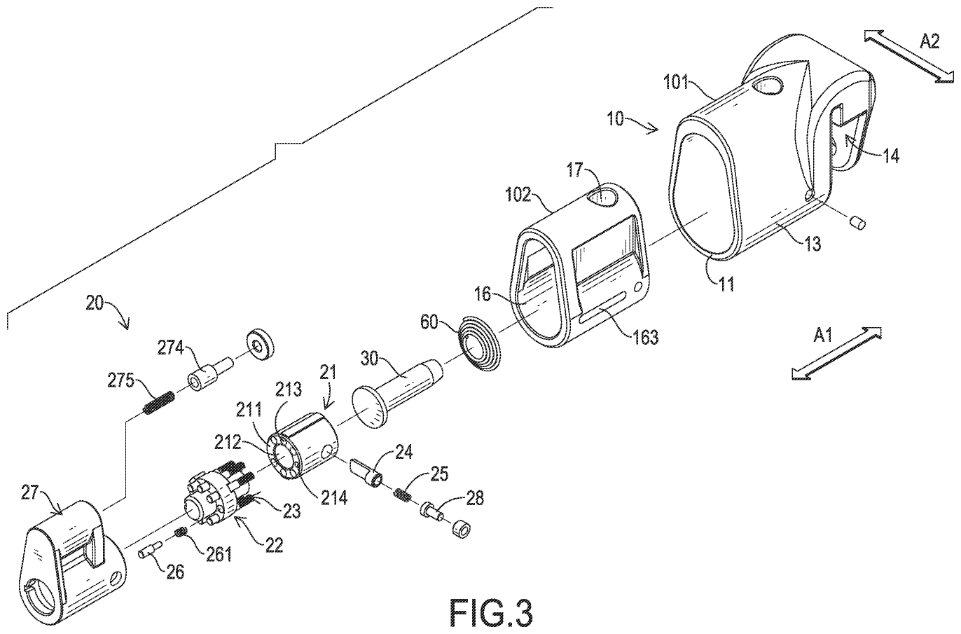

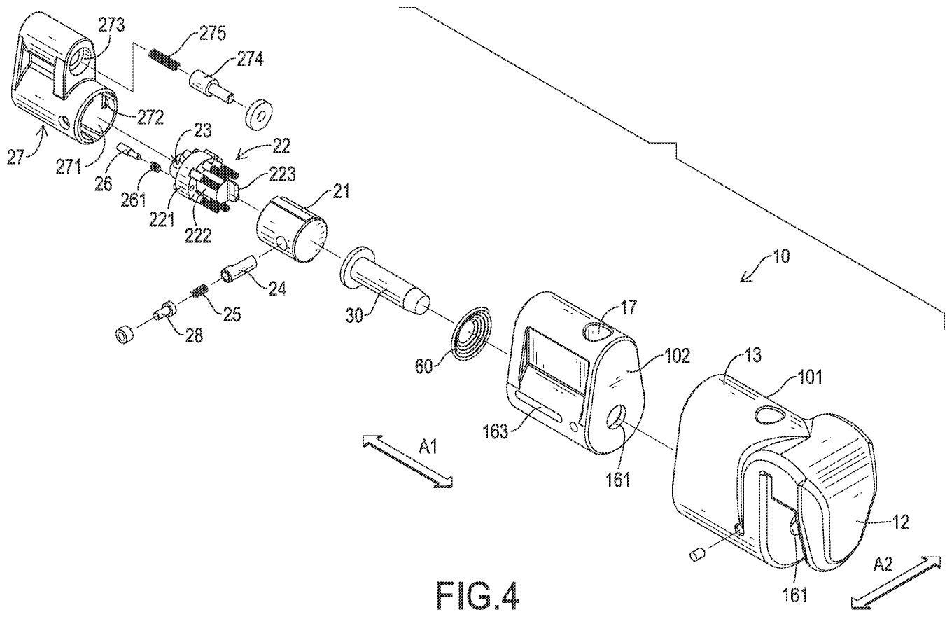

To be more precise, with reference to FIGS. 3 and 4, in this embodiment, the lock casing 10 may include a shell unit 101 and an inner wall unit 102, and the inner wall unit 102 is engaged in the shell unit 101. The installation slot 14 is formed on the shell unit 101, and the lock core recess 16, the cable slot 17, the outer lock hole 162, and the limit track 163 are formed on the inner wall unit 102. Besides, the communicating hole 161 is formed through the shell unit 101 and the inner wall unit 102. The outer lock hole 162 and the limit track 163 are formed on the inner wall unit 102 and covered by the shell unit 101, but it is not limited thereto. In another embodiment, the lock casing 10 may be formed integrally instead of divided into the shell unit 101 and the inner wall unit 102.

The cable slot 17 is recessed from the peripheral surface 13; to be more precise, the cable slot 17 is recessed on the inner wall unit 102 and formed through the shell unit 101. A lateral through hole 171 is formed through an inner wall surface of the cable slot 17, and the cable slot 17 and the lock core recess 16 spatially communicate with each other via the lateral through hole 171.

With reference to FIGS. 2 to 4, the lock core assembly 20 is movably mounted in the lock core recess 16. The lock core assembly 20 includes an inner base 21, an outer base 22, multiple lock pin modules 23, a core fixing bar 24, a first elastic unit 25, a base inner pin 26, and a core sleeve 27.

With reference to FIGS. 3, 4, 7, and 8, the inner base 21 is movably mounted in the lock core recess 16. The inner base 21 has an abutting surface 211, an accommodating recess 212, multiple pin chambers 213, a base pin hole 214, and an inner lock hole 215.

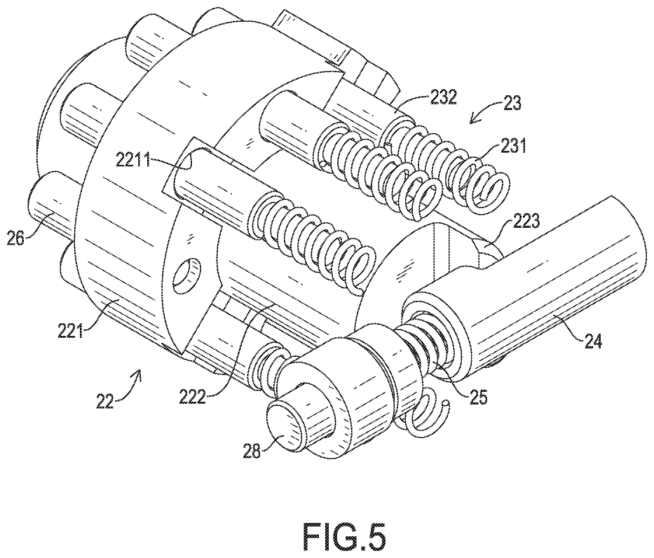

With reference to FIGS. 5 to 8, the abutting surface 211 faces towards the front end surface 11 of the lock casing 10. The accommodating recess 212 is recessed from the abutting surface 211, and a rotate-limit recess 2121 is formed in the accommodating recess 212. The rotate-limit recess 2121 is recessed from a bottom surface of the accommodating recess 212, the rotate-limit recess 2121 has a limit surface 2122, and the limit surface 2122 and the outer base 22 abut each other. In this embodiment, the accommodating recess 212 is cylindrical in shape and thus has a bottom surface and an inner wall surface, and the rotate-limit recess 2121 is recessed from the bottom surface of the accommodating recess 212.

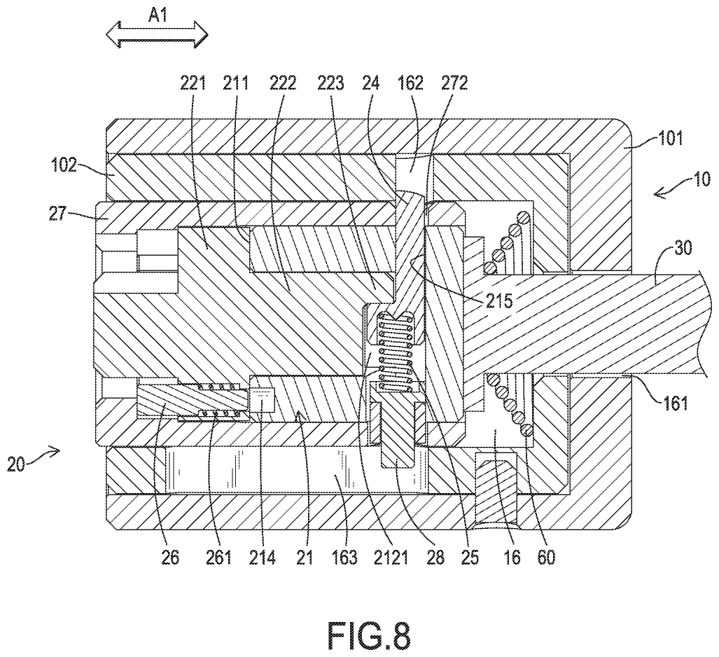

With reference to FIGS. 3 and 8, the pin chambers 213 are recessed from the abutting surface 211. The pin chambers 213 are spaced apart from each other and together surround the accommodating recess 212. The base pin hole 214 is recessed from the abutting surface 211, and arranged spaced apart from the pin chambers 213, but it is not limited thereto, as the inner base 21 may not include the base pin hole 214. The inner lock hole 215 is formed through the inner wall surface of the accommodating recess 212, the inner lock hole 215 is aligned with the outer lock hole 162, and the inner lock hole 215 and the outer lock hole 162 spatially communicate with each other.

With reference to FIGS. 4 to 6, 8, and 9, the outer base 22 is rotatably connected to the inner base 21, and the outer base 22 is rotatable with respect to the inner base 21. The outer base 22 has an abutting portion 221, a rotating axis portion 222, and a pressing protrusion 223. The abutting portion 221 abuts the abutting surface 211 of the inner base 21, and multiple pin channels 2211 are formed through the abutting portion 221. Each one of the pin channels 2211 spatially communicates with a corresponding one of the pin chambers 213 selectively. To be more precise, in this embodiment, the abutting portion 221 is shaped like a disc and has two opposite disc surfaces, and one of the disc surfaces of the abutting portion 221 abuts the abutting surface 211 of the inner base 21. Each one of the pin channels 2211 is formed through and spatially communicates with the two opposite disc surfaces of the abutting portion 221, and each one of the pin channels 2211 is aligned with the corresponding pin chamber 213.

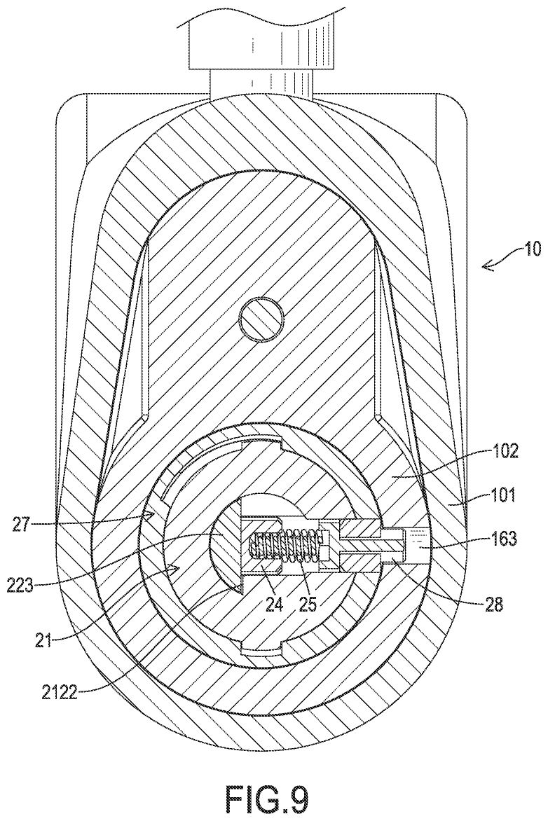

The rotating axis portion 222 is connected to the abutting portion 221, and the rotating axis portion 222 is rotatably disposed in the accommodating recess 212. The pressing protrusion 223 is mounted on the rotating axis portion 222 and located in the accommodating recess 212. To be more precise, in this embodiment, the rotating axis portion 222 is cylindrical in shape and is coaxially connected to one of the disc surfaces of the abutting portion 221, the rotating axis portion 222 is disposed in the accommodating recess 212, and an end surface of the rotating axis portion 222 faces towards the bottom surface of the accommodating recess 212, but it is not limited thereto. With reference to FIGS. 8 and 9, the pressing protrusion 223 is mounted on the end surface of the rotating axis portion 222, and said end surface of the rotating axis portion 222 faces towards the bottom surface of the accommodating recess 212. The pressing protrusion 223 is located in the rotate-limit recess 2121 and detachably abuts the limit surface 2122.

With reference to FIGS. 4 to 7, each one of the lock pin modules 23 is movably mounted in a corresponding one of the pin chambers 213 and a corresponding one of the pin channels 2211. To be more precise, each one of the lock pin modules 23 includes a pin spring 231 and a pin set 232, and the pin spring 231 is disposed in the pin chamber 213 to reset the pin set 232. Each one of the pin sets 232 has a driver pin 2321 and a key pin 2322, the driver pin 2321 and the key pin 2322 abut each other, and thus an interface is formed between the driver pin 2321 and the key pin 2322. Lengths of the driver pins 2321 and the key pins 2322 of the pin sets 232 may be different from each other, and the driver pins 2321 and the key pins 2322 may be manufactured to match with a key (not shown in the figures) of the bicycle lock.

With reference to FIGS. 4, 6, 8, and 9, the core fixing bar 24 is located in the accommodating recess 212, and the core fixing bar 24 is movably mounted through the inner lock hole 215 and the outer lock hole 162. The core fixing bar 24 abuts the pressing protrusion 223 of the outer base 22, and thereby the outer base 22 is capable of pushing the core fixing bar 24 to move away from the outer lock hole 162. The first elastic unit 25 is connected to the core fixing bar 24 and located in the accommodating recess 212, and the first elastic unit 25 is capable of pushing the core fixing bar 24 to move toward the outer lock hole 162, thereby resetting the core fixing bar 24. When the pressing protrusion 223 and the limit surface 2122 abut each other, the first elastic unit 25 pushes the core fixing bar 24 into the outer lock hole 162.

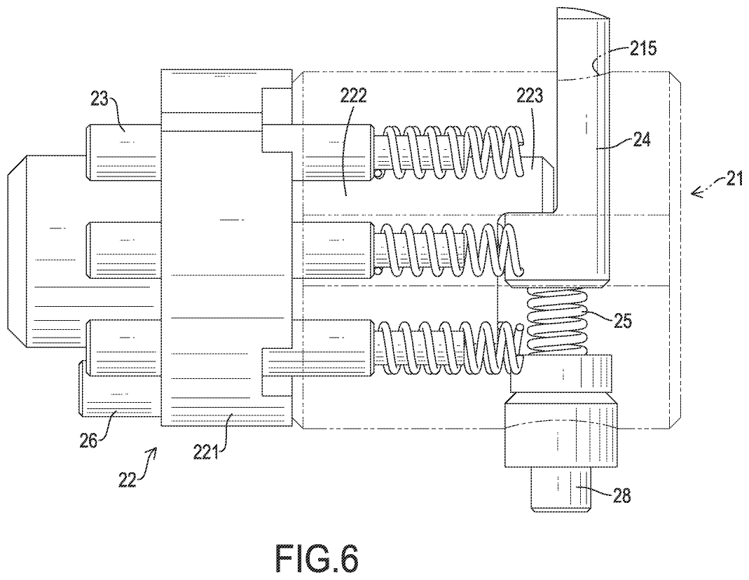

With reference to FIGS. 6, 8, and 9, in this embodiment, the lock core assembly 20 has a limit protrusion 28 which is connected to the first elastic unit 25. The limit protrusion 28 protrudes outward from the inner base 21 and located in the limit track 163, but it is not limited thereto, as the limit protrusion 28 may not be connected to the first elastic unit 25.

With reference to FIGS. 4, 6, and 8, the base inner pin 26 is mounted through the abutting portion 221 of the outer base 22, and the base inner pin 26 is movable toward the inner base 21. The base pin hole 214 is aligned with the base inner pin 26, and thus the base inner pin 26 is capable of moving into the base pin hole 214. Besides, the outer base 22 may have a restore elastic unit 261 sleeved on the base inner pin 26 to reset the base inner pin 26.

With reference to FIGS. 3, 4, and 7 to 9, the core sleeve 27 is movably mounted in the lock core recess 16. The core sleeve 27 has a first mounting slot 271, a middle lock hole 272, a second mounting slot 273, a cable fixing bar 274, and a second elastic unit 275.

With reference to FIGS. 3, 4, 7, and 8, the first mounting slot 271 is formed through the core sleeve 27 along the front-back direction A1, and the inner base 21, the outer base 22, and the lock pin modules 23 are disposed in the first mounting slot 271. The middle lock hole 272 is formed through an inner wall surface of the first mounting slot 271, and the inner lock hole 215 and the outer lock hole 162 spatially communicate with each other via the middle lock hole 272. The core fixing bar 24 is mounted through the middle lock hole 272. The second mounting slot 273 is recessed from a surface of the core sleeve 27, and said surface of the core sleeve 27 faces towards the lateral through hole 171 of the inner wall unit 102. The second mounting slot 273 and the lateral through hole 171 spatially communicate with each other. The cable fixing bar 274 is movably disposed in the second mounting slot 273, and the cable fixing bar 274 is mounted through the lateral through hole 171 of the cable slot 17. The second elastic unit 275 is disposed in the second mounting slot 273, two ends of the second elastic unit 275 respectively abut a bottom surface of the second mounting slot 273 and the cable fixing bar 274, and thereby the second elastic unit 275 is capable of pushing the cable fixing bar 274 to move toward the lateral through hole 171.

The lock bar 30 is connected to the lock core assembly 20 and disposed through the communicating hole 161 of the lock core recess 16. The lock bar 30 is capable of moving into the installation slot 14. To be more precise, the bicycle lock may have a core spring 60 sleeved on the lock bar 30, and an end of the lock bar 30 abuts the inner base 21 of the lock core assembly 20. Two ends of the core spring 60 respectively abut the lock bar 30 and the bottom surface of the lock core recess 16. Thus, the core spring 60 is capable of pushing the lock core assembly 20 and the lock bar 30 to move along the front-back direction A1 in the lock core recess 16, but it is not limited thereto; in another embodiment, the bicycle may not have the core spring 60.

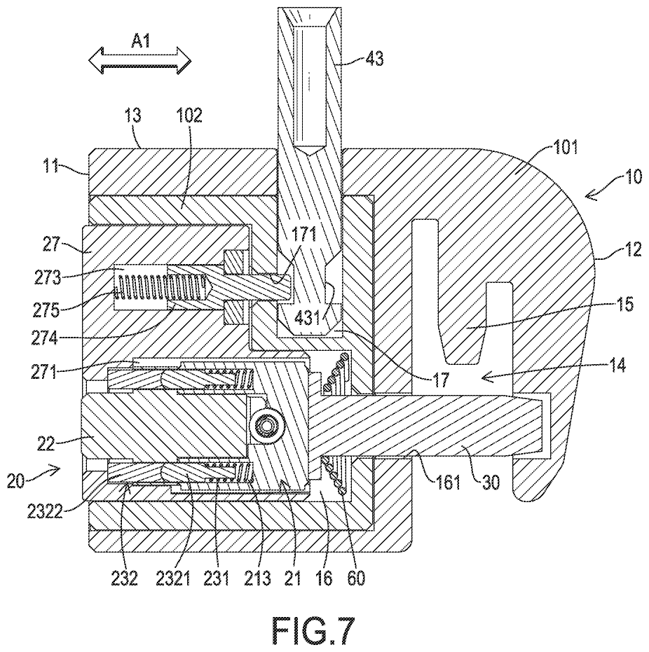

With reference to FIGS. 1 and 7, the lock cable 40 includes a cable body 41, a ring part 42, and a plug 43. The cable body 41 has two ends opposite to each other, the ring part 42 is connected to one of the two ends of the cable body 41, and the plug 43 is connected to another one of the two ends of the cable body 41. The plug 43 is mounted in the cable slot 17. The plug 43 and the cable fixing bar 274 detachably abut each other, and thereby the plug 43 is fixed in the cable slot 17. To be more precise, the plug 43 has an engaging recess 431 which is recessed from an outer annular surface of the plug 43, and when the plug 43 is in the cable slot 17, the cable fixing bar 274 may extend into the engaging recess 431, such that the plug 43 cannot be pulled out from the cable slot 17.

With reference to FIGS. 7 to 9, when the bicycle lock is locked, the lock bar 30 extends into the installation slot 14. Likely, the cable fixing bar 274 extends into the cable slot 17, and further extends into the engaging recess 431 of the plug 43 of the lock cable 40, thereby the cable fixing bar 274 and the plug 43 abut each other, and thus the plug 43 cannot be pulled out from the cable slot 17. The core fixing bar 24 is disposed through the inner lock hole 215, the middle lock hole 272, and the outer lock hole 162 at the same time to fix a relative position of the lock core assembly 20 with respect to the inner wall unit 102, and then indirectly fixes positions of the lock bar 30 and the cable fixing bar 274. Meanwhile, the pressing protrusion 223 of the outer base 22 abuts the limit surface 2122 of the rotate-limit recess 2121.

When unlocking the bicycle lock, the user inserts a corresponding key into the first mounting slot 271 via the front end surface 11 of the lock casing 10. The corresponding key is capable of pushing the pin sets 232 of the lock pin modules 23 to move into the pin channels 2211 and the pin chambers 213; once the interface between the driver pin 2321 and the key pin 2322 of each one of the pin sets 232 is aligned with the abutting surface 211 of the inner base 21, and the base inner pin 26 is out of the base pin hole 214, the bicycle can rotate the corresponding key to rotate the outer base 22 with respect to the inner base 21. If a thief inserts a tubular tool such as a pen tube into the first mounting slot 271 in an attempt to unlock the bicycle lock, the base inner pin 26 will be pressed into the base pin hole 214, and thus the outer base 22 is non-rotatable with respect to the inner base 21. Therefore, the bicycle lock is capable of preventing breakage by the thief.

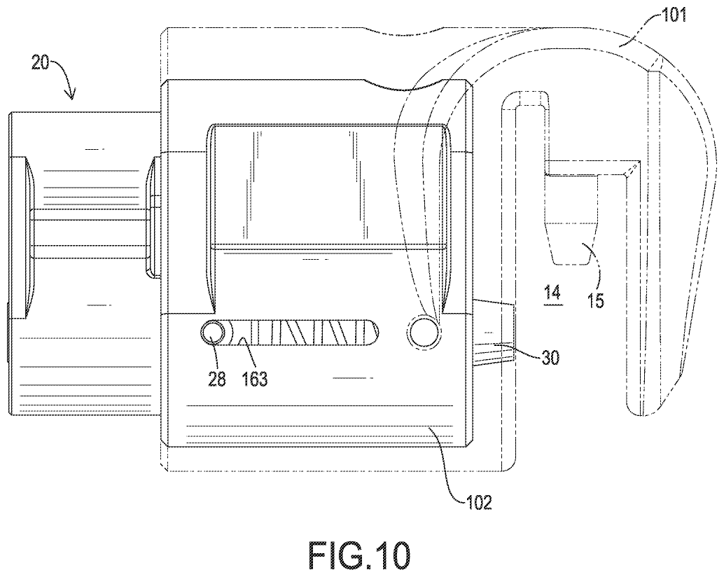

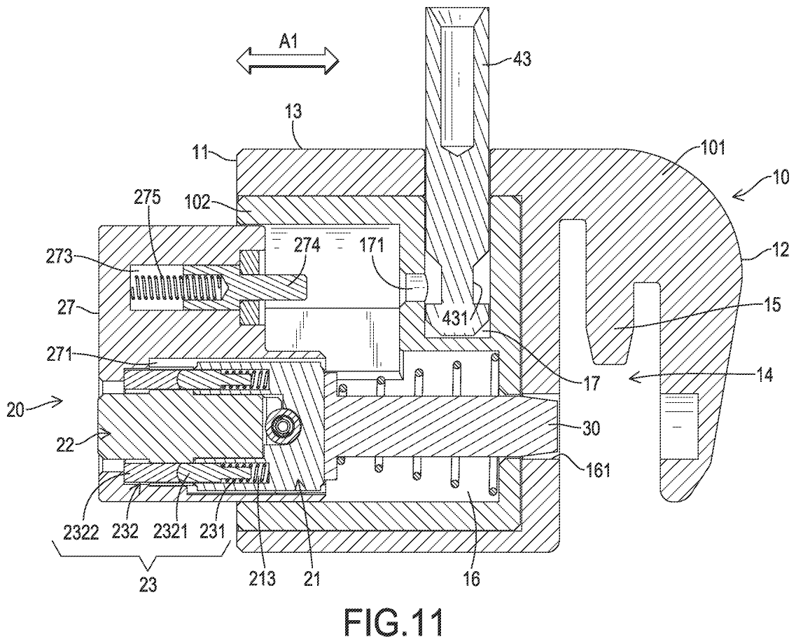

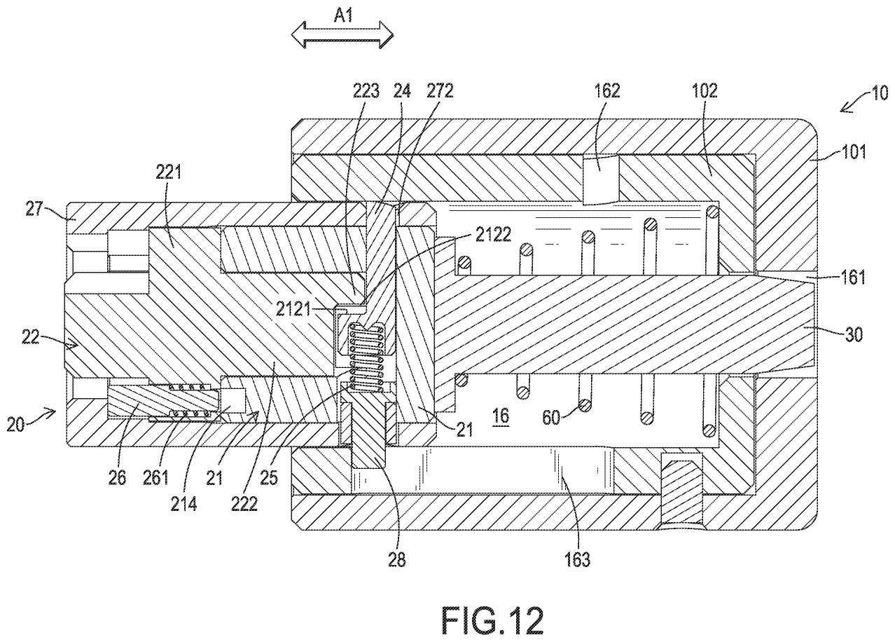

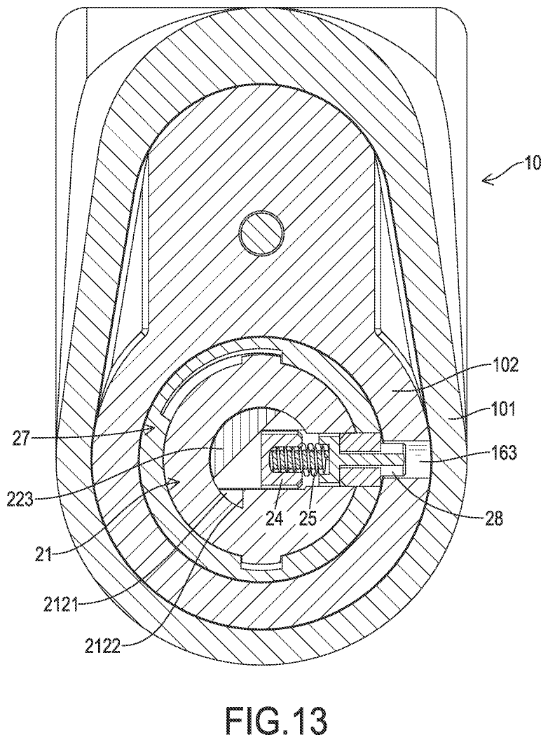

With reference to FIGS. 10 to 13, when the outer base 22 rotates with respect to the inner base 21, the pressing protrusion 223 of the outer base 22 is detached from the limit surface 2122. And then the pressing protrusion 223 presses the core fixing bar 24 to move with respect to the outer lock hole 162 and compresses the first elastic unit 25 at the same time until the core fixing bar 24 comes out of the outer lock hole 162. When the core fixing bar 24 is completely out of the outer lock hole 162, the core spring 60 is capable of pushing the lock bar 30 as well as the lock core assembly 20 to move out from the front end surface 11 of the lock casing 10, and thus the lock bar 30 moves out of the installation slot 14 as well as the cable fixing bar 274 moves out of the cable slot 17, and the bicycle lock is unlocked. Besides, by limiting a moving range of the limit protrusion 28 with the limit track 163, a moving range of the lock core recess 16 with respect to the lock core assembly 20 is also limited, and thus the lock core assembly 20 is prevented from separating from the lock core recess 16.

To lock the bicycle lock, the user only needs to press the lock core assembly 20 into the lock core recess 16 until the core fixing bar 24 is aligned with the outer lock hole 162, and then the core fixing bar 24 is pressed into the outer lock hole 162 by the first elastic unit 25 to fix the lock core assembly 20. In addition, an end of the plug 43 of the lock cable 40 is chamfered, and thus when the plug 43 is inserted into the cable slot 17, the cable fixing bar 274 is pressed to move into the second mounting slot 273 simultaneously, until the engaging recess 431 of the plug 43 is aligned with the lateral through hole 171. Then the cable fixing bar 274 is pushed back by the second elastic unit 275 to extend into the engaging recess 431 of the plug 43 to complete setting of the plug 43. Therefore, the lock cable 40 can be connected to and fixed with the lock casing 10 by directly inserting the plug 43 into the cable slot 17, instead of moving out the cable fixing bar 274 with the key before setting, and thus the bicycle lock simplifies the locking procedures, and is convenient for the user to use.

In this embodiment, the cable fixing bar 274 and the lock bar 30 are unlocked simultaneously due to the core sleeve 27; in other words, the user only needs to unlock once to drive out the lock bar 30 and the plug 43 of the lock cable 40 at the same time, thus being convenient, but it is not limited thereto. In another embodiment, the bicycle lock may not have the core sleeve 27 but set unlock mechanisms for the cable fixing bar 274 and the lock bar 30 respectively.

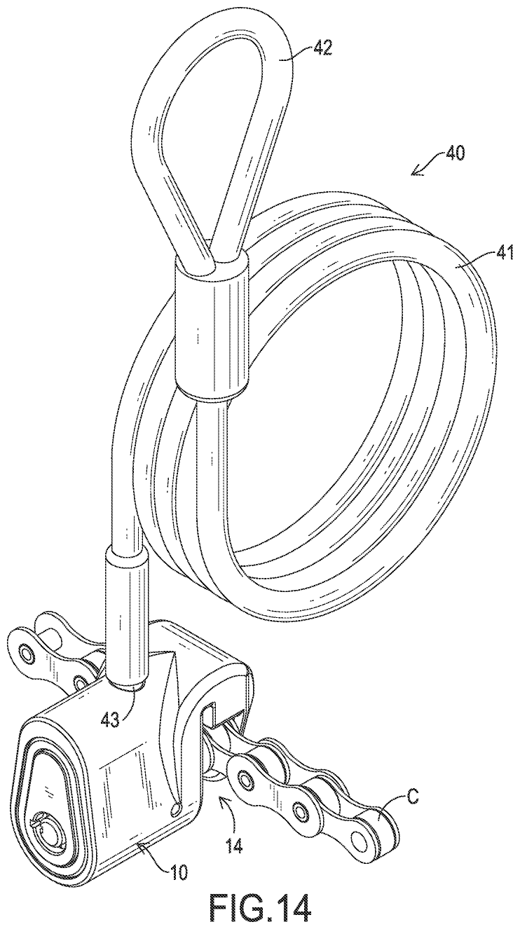

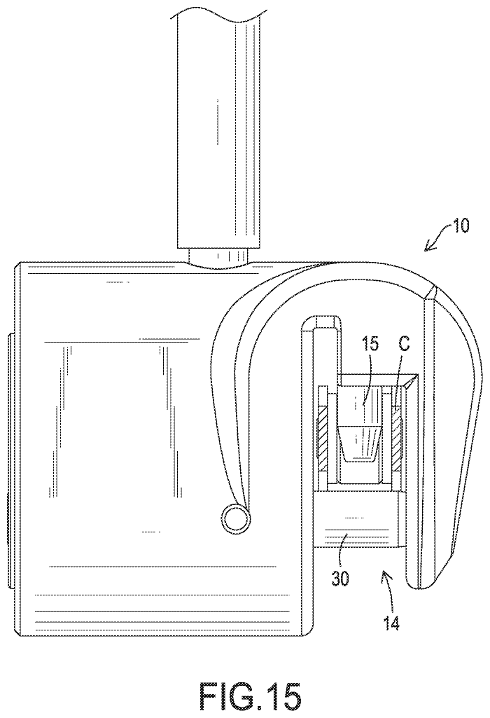

With reference to FIGS. 14 and 15, when the bicycle lock is fixed and locked on a chain C of a bicycle, the chain C is mounted through the installation slot 14 along the penetrating direction A2, and the fixed pin 15 is inserted into a hole of one of rollers of the chain C. Then the lock bar 30 extends into the installation slot 14 and blocks the chain C, thereby preventing the chain C from separating from the installation slot 14, and fixing a relative position of the chain C with respect to the lock casing 10, and therefore, the setting of the bicycle lock on the chain C is completed. Since the fixed pin 15 is inserted into the roller of the chain C, and the lock bar 30 blocks the chain C, the bicycle lock is fixed and locked on the chain C and would move along with the chain C, and thus the chain C would be interfered and incapable of working normally, so as to prevent bicycle theft. Besides, the bicycle lock can be fixed on all structures like the chain C, and thus the bicycle lock is not limited to be applied to the bicycle only; for example, the bicycle lock may be applied to a chain of a motorcycle. In addition, the user may wrap the cable body 41 of the lock cable 40 on an external fixed structure, pass the end of the cable body 41 which is connected to the plug 43 through the ring part 42, and insert the plug 43 into the cable slot 17, to prevent the bicycle from being carried away.

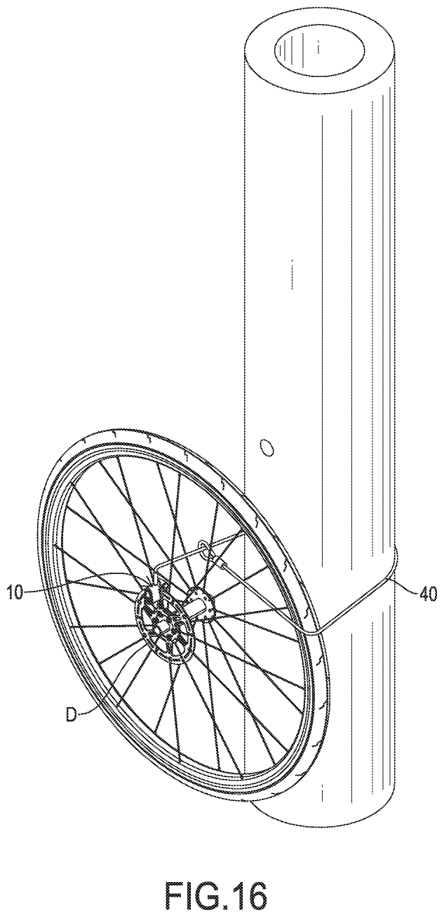

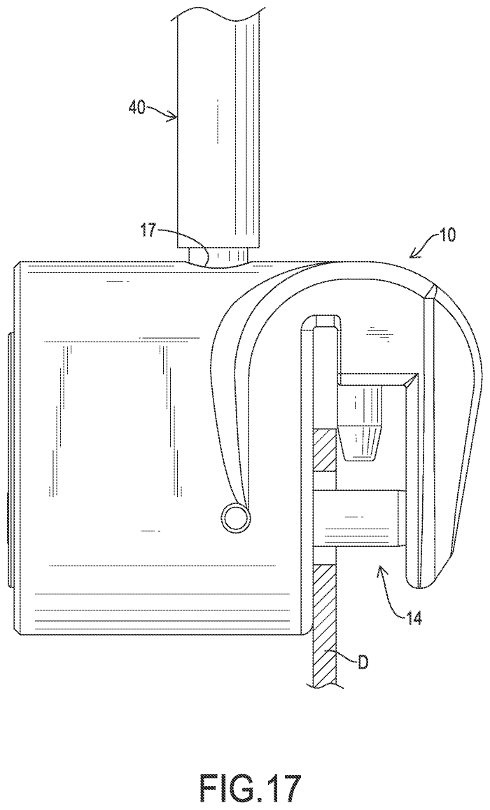

With reference to FIGS. 16 and 17, the bicycle lock may be fixed and locked on a brake disc D of the wheel. Likely, the user may wrap the lock cable 40 on a pillar and insert the plug 43 into the cable slot 17, thereby fixing the bicycle to the pillar and preventing the bicycle from being carried away. The brake disc D extends into the installation slot 14, and the lock bar 30 passes through a hole of the brake disc D. Therefore, the bicycle lock is also capable of being fixed and locked on the brake disc D.

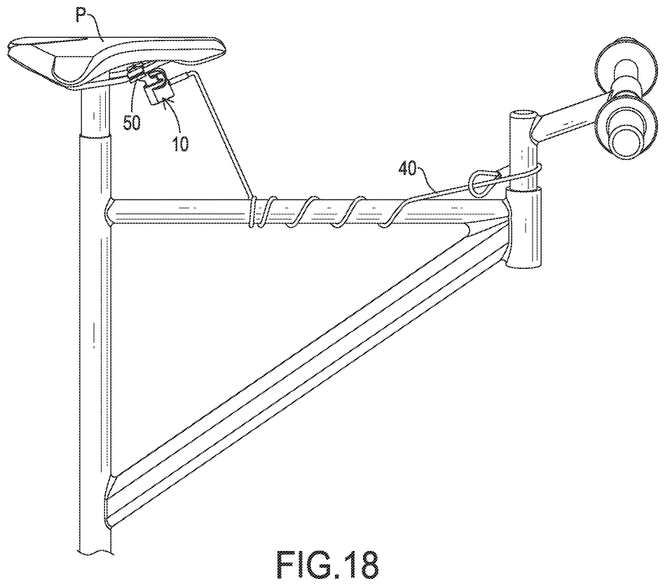

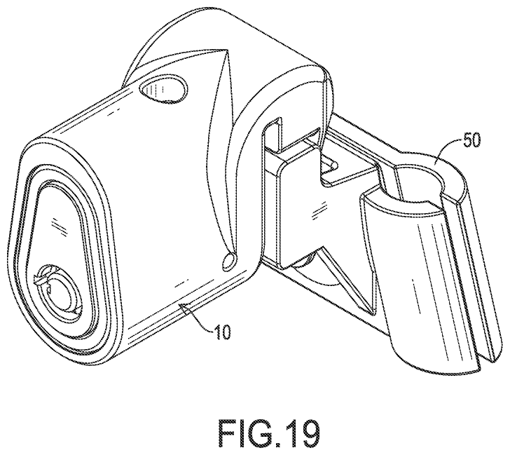

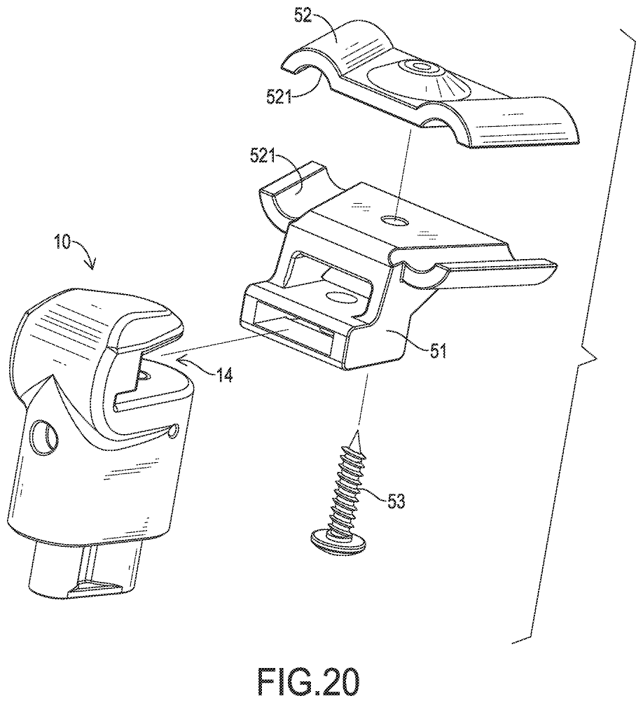

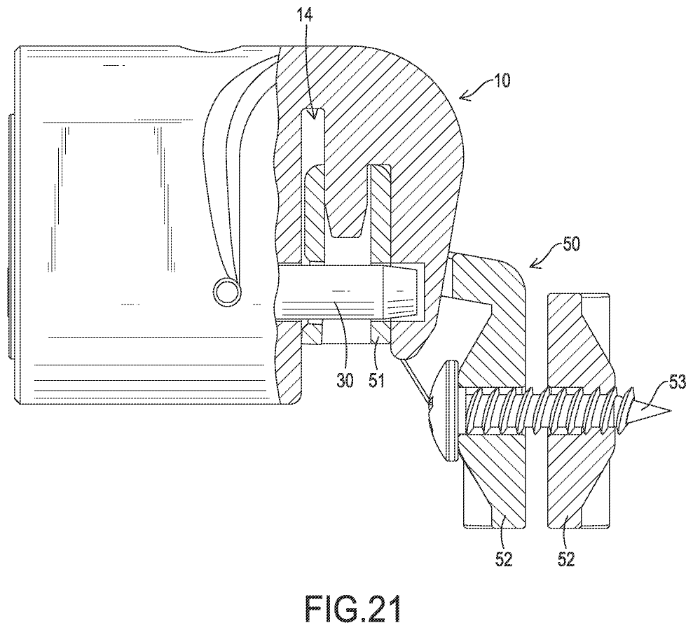

With reference to FIGS. 18 to 21, in another embodiment of a bicycle lock in accordance with the present invention, the bicycle lock may have a connector 50. The connector 50 can be mounted on a saddle P of the bicycle to prevent loss when the bicycle lock is unlocked and not in use, and avoid interfering with the user riding the bicycle, but it is not limited thereto, as the connector 50 may be connected to another part of the bicycle.

The connector 50 and the lock casing 10 detachably connect with each other. The connector 50 has a buckle 51, two plate units 52, and a fixing unit 53. The buckle 51 is disposed in the installation slot 14 of the lock casing 10, the fixed pin 15 is disposed through the buckle 51, and the lock bar 30 is disposed through the buckle 51, thereby fixing the connector 50 with the lock casing 10. The two plate units 52 detachably connect with each other, and the buckle 51 is mounted on one of the plate units 52. The fixing unit 53 is mounted through the two plate units 52, thereby adjusting a distance between the two plate units 52.

Each one of the plate units 52 has two clamping grooves 521 respectively formed at two opposite edges of the plate unit 52. Each one of the clamping grooves 521 is recessed away from another one of the plate units 52, and with the fixing unit 53 adjusting the distance between the two plate units 52, the two plate units 52 together clamp on bars beneath the saddle P of the bicycle via the clamping grooves 521. Then set the lock casing 10 to the connector 50 to connect to the saddle P. Furthermore, the user may wrap the cable body 41 on a frame of the bicycle and then insert the plug 43 into the cable slot 17, such that the bicycle lock would not be lost, and the bicycle lock would not affect the user riding the bicycle.

In summary, the bicycle lock in this disclosure is capable of being fixed and locked on the chain C to interfere with operation of the chain C, thereby preventing theft. To compare with a wheel lock, the bicycle lock in this disclosure would not damage a rim and spokes of a wheel. Besides, with the lock cable 40, the bicycle lock is capable of connecting the bicycle with an external fixed structure such as fences to prevent the bicycle from being carried away.

To lock the bicycle lock, the user only needs to press the lock core assembly 20 into the lock core recess 16 until the core fixing bar 24 is aligned with the outer lock hole 162 and pushed into the outer lock hole 162 by the first elastic unit 25, to fix the lock core assembly 20. In addition, the plug 43 of the lock cable 40 can be fixed and locked by being directly inserted into the cable slot 17. The locking procedures of the bicycle is simple, convenient to use without complicated procedures. The user may fix the bicycle lock on the bicycle except the lock cable 40, wrap the lock cable 40 on the external fixed structure and the frame of the bicycle to a satisfying state, and then insert the plug 43 into the cable slot 17 to finish. The bicycle lock does not have a lock body unremovable from the lock cable 40, since the bicycle lock may be locked simply with the plug 43 inserted into the cable slot 17, the bicycle lock can be easily fixed on the bicycle even though the lock cable 40 is wrapped a little tightly. The user does not have to remove the lock cable 40 from the bicycle just because the lock body cannot be set at a desired site. Besides, the bicycle lock does not have the lock body occupying large space which leads to difficulties about crossing gaps, and thus the user can wrap the lock cable 40 at the sites desired. Furthermore, to unlock the bicycle lock, after the plug 43 is separated from the cable slot 17, the lock cable 40 can be disconnected from the lock casing 10, and thus the user can easily remove the lock cable 40 from the frame of the bicycle and the external fixed structure.

Due to the inner base 21 and the outer base 22 mounted in the first mounting slot 271 and the cable fixing bar 274 disposed in the second mounting slot 273 of the core sleeve 27, when the user unlocks the bicycle lock, the lock bar 30 and the cable fixing bar 274 can be ejected as the same time instead of unlocking separately. The base inner pin 26 would prevent the outer base 22 rotating with respect to the inner base 21 once the base inner pin 26 is moved, and thus the base inner pin 26 can prevent the thief from unlocking the bicycle lock with tools such as the pen tube, enhancing protection.

Moreover, when the user temporarily unlocks the bicycle lock, the user can set the bicycle lock to another site of the bicycle with the connector 50 to prevent loss of the bicycle.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A bicycle lock including:
a lock casing having a front-back direction; the lock casing including:
a front end surface and a back end surface located on two opposite ends of the lock casing along the front-back direction;
a peripheral surface connecting with the front end surface and the back end surface;
an installation slot recessed from the peripheral surface and adjacent to the back end surface; the installation slot having a penetrating direction non-parallel to the front-back direction;
a fixed pin, and an end of the fixed pin secured on a bottom surface of the installation slot;
a lock core recess recessed from the front end surface of the lock casing, the lock core recess including:
a communicating hole formed through a bottom surface of the lock core recess, and thereby the lock core recess and the installation slot spatially communicating with each other; and
a cable slot recessed from the peripheral surface;
a lock core assembly movably mounted in the lock core recess;
a lock bar, an end of the lock bar connected to the lock core assembly and another end of the lock bar disposed through the communicating hole, the lock bar configured to be moved into the installation slot; and
a lock cable detachably mounted in the cable slot of the lock casing.

2. The bicycle lock as claimed in claim 1, wherein
the lock core recess of the lock casing has
an outer lock hole recessed from an inner wall surface of the lock core recess; and
the lock core assembly includes
an inner base movably mounted in the lock core recess, and the inner base having
an abutting surface facing the front end surface of the lock casing;
an accommodating recess recessed from the abutting surface;
multiple pin chambers recessed from the abutting surface, the multiple pin chambers spaced from each other and together surrounding the accommodating recess;
an inner lock hole formed through an inner wall surface of the accommodating recess; the inner lock hole aligned with the outer lock hole, and the inner lock hole and the outer lock hole spatially communicating with each other;
an outer base rotatably connected to the inner base, the outer base having
an abutting portion abutting the abutting surface of the inner base, and multiple pin channels formed through the abutting portion; each one of the multiple pin channels spatially communicating with a corresponding one of the multiple pin chambers;
a rotating axis portion connected to the abutting portion and rotatably disposed in the accommodating recess, thereby the outer base being rotatable with respect to the inner base;
a pressing protrusion mounted on the rotating axis portion and located in the accommodating recess;
multiple lock pin modules, each one of the multiple lock pin modules movably mounted in both one of the pin chambers and one of the pin channels;
a core fixing bar located in the accommodating recess, and movably mounted through the inner lock hole and the outer lock hole, the core fixing bar abutting the pressing protrusion of the outer base, thereby the pressing protrusion capable of pushing the core fixing bar to move away from the outer lock hole; and
a first elastic unit connected to the core fixing bar and located in the accommodating recess, the first elastic unit capable of pushing the core fixing bar to move toward the outer lock hole.

3. The bicycle lock as claimed in claim 2, wherein
the accommodating recess of the inner base has
a rotate-limit recess recessed from a bottom surface of the accommodating recess, and the rotate-limit recess having a limit surface; and
the pressing protrusion of the outer base is disposed on a surface of the rotating axis portion, said surface of the rotating axis portion faces towards the bottom surface of the accommodating recess; the pressing protrusion is located in the rotate-limit recess, and detachably abuts the limit surface; and
when the pressing protrusion abuts the limit surface, the core fixing bar is disposed through the outer lock hole.

4. The bicycle lock as claimed in claim 2, wherein
the lock core assembly has
a base inner pin mounted through the abutting portion of the outer base, and capable of moving toward the inner base; and
the inner base has:
a base pin hole recessed from the abutting surface, and the base pin hole aligned with the base inner pin;
wherein, the base inner pin is configured to move into the base pin hole.

5. The bicycle lock as claimed in claim 3, wherein
the lock core assembly has
a base inner pin mounted through the abutting portion of the outer base, and capable of moving toward the inner base; and
the inner base has:
a base pin hole recessed from the abutting surface, and the base pin hole aligned with the base inner pin;
wherein, the base inner pin is configured to move into the base pin hole.

6. The bicycle lock as claimed in claim 1, wherein
the lock casing has
a limit track recessed from the inner wall surface of the lock core recess, and the limit track extending along the front-back direction; and
the lock core assembly has
a limit protrusion disposed in the limit track.

7. The bicycle lock as claimed in claim 5, wherein
the lock casing has
a limit track recessed from the inner wall surface of the lock core recess, and the limit track extending along the front-back direction; and
the lock core assembly has
a limit protrusion disposed in the limit track.

8. The bicycle lock as claimed in claim 1, wherein, the lock cable includes
a cable body having two ends opposite to each other;
a ring part connected to one of the two ends of the cable body; and
a plug connected to another one of the two ends and mounted in the cable slot.

9. The bicycle lock as claimed in claim 7, wherein, the lock cable includes
a cable body having two ends opposite to each other;
a ring part connected to one of the two ends of the cable body; and
a plug connected to another one of the two ends and mounted in the cable slot.

10. The bicycle lock as claimed in claim 2, wherein
the cable slot has
a lateral through hole formed through an inner wall surface of the cable slot, and thereby the cable slot and the lock core recess spatially communicating with each other;
the lock core assembly has
a core sleeve movably mounted in the lock core recess; the core sleeve having
a first mounting slot formed through the core sleeve along the front-back direction; the inner base, the outer base, and the multiple lock pin modules disposed in the first mounting slot;
a middle lock hole formed through an inner wall surface of the first mounting slot, the inner lock hole and the outer lock hole spatially communicating with each other via the middle lock hole, and the core fixing bar mounted through the middle lock hole; and
a cable fixing bar mounted through the lateral through hole of the cable slot; and
the lock cable has
a cable body having two ends opposite to each other;
a ring part connected to one of the two ends of the cable body; and
a plug connected to another one of the two ends of the cable body and mounted in the cable slot, the plug and the cable fixing bar detachably abutting each other, thereby fixing the plug in the cable slot.

11. The bicycle lock as claimed in claim 7, wherein
the cable slot has
a lateral through hole formed through an inner wall surface of the cable slot, and thereby the cable slot and the lock core recess spatially communicating with each other;
the lock core assembly has
a core sleeve movably mounted in the lock core recess; the core sleeve having
a first mounting slot formed through the core sleeve along the front-back direction; the inner base, the outer base, and the multiple lock pin modules disposed in the first mounting slot;
a middle lock hole formed through an inner wall surface of the first mounting slot, the inner lock hole and the outer lock hole spatially communicating with each other via the middle lock hole, and the core fixing bar mounted through the middle lock hole; and
a cable fixing bar mounted through the lateral through hole of the cable slot; and
the lock cable has
a cable body having two ends opposite to each other;
a ring part connected to one of the two ends of the cable body; and
a plug connected to another one of the two ends of the cable body and mounted in the cable slot, the plug and the cable fixing bar detachably abutting each other, thereby fixing the plug in the cable slot.

12. The bicycle lock as claimed in claim 10, wherein, the core sleeve has
a second mounting slot recessed from a surface of the core sleeve, and said surface of the core sleeve facing towards the lateral through hole of the lock casing; the second mounting slot and the lateral through hole spatially communicating with each other, and the cable fixing bar movably mounted in the second mounting slot; and
a second elastic unit disposed in the second mounting slot, two ends of the second elastic unit respectively abutting the cable fixing bar and a bottom surface of the second mounting slot.

13. The bicycle lock as claimed in claim 11, wherein, the core sleeve has
a second mounting slot recessed from a surface of the core sleeve, and said surface of the core sleeve facing towards the lateral through hole of the lock casing; the second mounting slot and the lateral through hole spatially communicating with each other, and the cable fixing bar movably mounted in the second mounting slot; and
a second elastic unit disposed in the second mounting slot, two ends of the second elastic unit respectively abutting the cable fixing bar and a bottom surface of the second mounting slot.

14. The bicycle lock as claimed in claim 1, wherein the bicycle lock has
a connector detachably connected to the lock casing; the connector having
a buckle disposed in the installation slot of the lock casing; the fixed pin disposed through the buckle, and the lock bar disposed through the buckle.

15. The bicycle lock as claimed in claim 9, wherein the bicycle lock has
a connector detachably connected to the lock casing; the connector having
a buckle disposed in the installation slot of the lock casing; the fixed pin disposed through the buckle, and the lock bar disposed through the buckle.

16. The bicycle lock as claimed in claim 13, wherein the bicycle lock has
a connector detachably connected to the lock casing; the connector having
a buckle disposed in the installation slot of the lock casing; the fixed pin disposed through the buckle, and the lock bar disposed through the buckle.

17. The bicycle lock as claimed in claim 14, wherein the connector has
two plate units detachably connecting with each other, and the buckle mounted on one of the two plate units; and
a fixing unit mounted through the two plate units, thereby adjusting a distance between the two plate units.

18. The bicycle lock as claimed in claim 15, wherein the connector has
two plate units detachably connecting with each other, and the buckle mounted on one of the two plate units; and
a fixing unit mounted through the two plate units, thereby adjusting a distance between the two plate units.

19. The bicycle lock as claimed in claim 16, wherein the connector has:
two plate units detachably connecting with each other, and the buckle mounted on one of the two plate units; and
a fixing unit mounted through the two plate units, thereby adjusting a distance between the two plate units.
